(19) United States
(12) Patent Application Publication
(10) Pub. No.: US 2021/0174201 A1
(43) Pub. Date: Jun. 10, 2021

(54) COMPUTING DEVICE, OPERATING METHOD OF COMPUTING DEVICE, AND STORAGE MEDIUM

(71) Applicant: Samsung Electronics Co., Ltd., Suwon-si (KR)

(72) Inventors: In HUH, Seoul (KR); Sanghoon MYUNG, Goyang-si (KR); Wonik JANG, Suwon-si (KR); Changwook JEONG, Hwaseong-si (KR)

(73) Assignee: Samsung Electronics Co., Ltd., Suwon-si (KR)

(21) Appl. No.: 16/907,780

(22) Filed: Jun. 22, 2020

(30) Foreign Application Priority Data
Dec. 5, 2019 (KR) 10-2019-0160280

(51) Int. Cl. G06N 3/08; G06K 9/62; G06N 5/04

(52) U.S. Cl. CPC G06N 3/08; G06N 5/04; G06K 9/6256

(57) ABSTRACT

A computing device includes memory storing computer-executable instructions; and processing circuitry configured to execute the computer-executable instructions such that the processing circuitry is configured to operate as a machine learning generator configured to receive semiconductor process parameters, to generate semiconductor process result information from the semiconductor process parameters, and to output the generated semiconductor process result information; and operate as a machine learning discriminator configured to receive the generated semiconductor process result information from the machine learning generator and to discriminate whether the generated semiconductor process result information is true.

### CROSS-REFERENCE TO RELATED APPLICATIONS

This application claims priority under 35 U.S.C. § 119 to Korean Patent Application No. 10-2019-0160280 filed on Dec. 5, 2019, in the Korean Intellectual Property Office, the disclosure of which is incorporated by reference herein in its entirety.

### BACKGROUND

### 1. Field

At least some example embodiments of the inventive concepts described herein relate to a computing device, and more particularly, relate to a computing device including a machine learning module configured to infer a result of a semiconductor process, an operating method of the computing device, and a storage medium storing instructions of the machine learning module.

### 2. Related Art

As technologies associated with machine learning develop, there is an attempt to apply the machine learning to various applications. When the machine learning is completed, the machine learning module may easily perform iterative operations or complicated operations. A physical model based computer simulation accompanying a huge amount of computational burden may be one of promising fields to which the machine learning is capable of being applied.

For example, a conventional physical model based computer simulation may be used to set process parameters to be applied to a semiconductor process and to calculate a semiconductor process result after the semiconductor process is performed. The physical model based computer simulation reduces costs necessary to implement a process actually but requires still a long time due to a huge amount of computational burden.

When the machine learning module is learned (or trained) to perform a function of the physical model based computer simulation, a time taken to calculate a semiconductor process result from semiconductor process parameters may be further shortened. However, the machine learning module may be learned under a stricter condition for the purpose of securing the reliability of the semiconductor process result.

### SUMMARY

At least some example embodiments of the inventive concepts provide a computing device including a machine learning module to perform the learning under a stricter condition and thus to infer a result of a semiconductor process from semiconductor process parameters with higher accuracy, an operating method of the computing device, and a storage medium storing instructions of the machine learning module.

According to at least some example embodiments of the inventive concepts, a computing device includes memory storing computer-executable instructions; and processing circuitry configured to execute the computer-executable instructions such that the processing circuitry is configured to operate as a machine learning generator configured to receive semiconductor process parameters, to generate semiconductor process result information from the semiconductor process parameters, and to output the generated semiconductor process result information; and operate as a machine learning discriminator configured to receive the generated semiconductor process result information from the machine learning generator and to discriminate whether the generated semiconductor process result information is true.

According to at least some example embodiments of the inventive concepts, an operating method of a computing device which includes one or more processors, includes performing supervised learning of a machine learning generator generating semiconductor process result information from semiconductor process parameters, by using at least one processor of the one or more processors; and performing learning of a generative adversarial network implemented with the machine learning generator and a machine learning discriminator, which discriminates whether the generated semiconductor process result information is true, by using the at least one processor.

According to at least some example embodiments of the inventive concepts, a non-transitory computer-readable storage medium stores instructions of a semiconductor process machine learning module, wherein the instructions, when executed by one or more processors, cause the one or more processors to perform operations, the operations including receiving semiconductor process parameters; and generating semiconductor process result information from the semiconductor process parameters, and wherein the semiconductor process machine learning module is a trained module that has been trained based on, a machine learning generator configured to generate the generated semiconductor process result information from the semiconductor process parameters and trained based on supervised learning, and a machine learning discriminator configured to discriminate whether the generated semiconductor process result information is true and to implement a generative adversarial network together with the machine learning generator.

### BRIEF DESCRIPTION OF THE FIGURES

The above and other features and advantages of example embodiments of the inventive concepts will become more apparent by describing in detail example embodiments of the inventive concepts with reference to the attached drawings. The accompanying drawings are intended to depict example embodiments of the inventive concepts and should not be interpreted to limit the intended scope of the claims. The accompanying drawings are not to be considered as drawn to scale unless explicitly noted.

FIG. 1 is a block diagram illustrating a computing device according to at least one embodiment of the inventive concepts.

FIG. 2 illustrates an example of a semiconductor process machine learning module according to at least a first example embodiment of the inventive concepts.

FIG. 3 is a flowchart illustrating an operating method of a semiconductor process machine learning module of FIG. 2.

FIG. 4 illustrates an example of a semiconductor process machine learning module according to at least a second example embodiment of the inventive concepts.

FIG. 5 is a flowchart illustrating an operating method of a semiconductor process machine learning module of FIG. 4.

FIG. 6 illustrates an example of a semiconductor process machine learning module according to at least a third example embodiment of the inventive concepts.

FIG. 7 is a flowchart illustrating an operating method of a semiconductor process machine learning module of FIG. 6.

FIG. 8 illustrates an example of a semiconductor process machine learning module according to at least a fourth example embodiment of the inventive concepts.

FIG. 9 is a flowchart illustrating an operating method of a semiconductor process machine learning module of FIG. 8.

FIG. 10 illustrates an example of a semiconductor process machine learning module according to at least a fifth example embodiment of the inventive concepts.

FIG. 11 illustrates an example of a semiconductor process machine learning module according to at least one embodiment of the inventive concepts.

FIG. 12 illustrates a result of a physical computer simulation and an inference result of a semiconductor process machine learning module.

### DETAILED DESCRIPTION

As is traditional in the field of the inventive concepts, embodiments are described, and illustrated in the drawings, in terms of functional blocks, units and/or modules. Those skilled in the art will appreciate that these blocks, units and/or modules are physically implemented by electronic (or optical) circuits such as logic circuits, discrete components, microprocessors, hard-wired circuits, memory elements, wiring connections, and the like, which may be formed using semiconductor-based fabrication techniques or other manufacturing technologies. In the case of the blocks, units and/or modules being implemented by microprocessors or similar, they may be programmed using software (e.g., microcode) to perform various functions discussed herein and may optionally be driven by firmware and/or software. Alternatively, each block, unit and/or module may be implemented by dedicated hardware, or as a combination of dedicated hardware to perform some functions and a processor (e.g., one or more programmed microprocessors and associated circuitry) to perform other functions. Also, each block, unit and/or module of the embodiments may be physically separated into two or more interacting and discrete blocks, units and/or modules without departing from the scope of the inventive concepts. Further, the blocks, units and/or modules of the embodiments may be physically combined into more complex blocks, units and/or modules without departing from the scope of the inventive concepts.

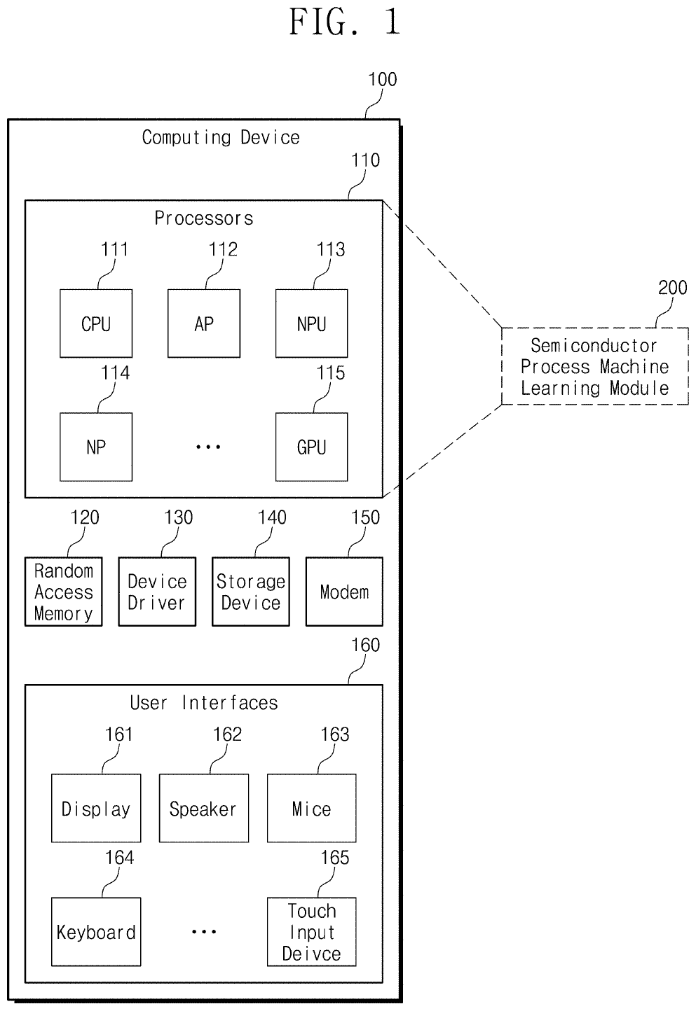

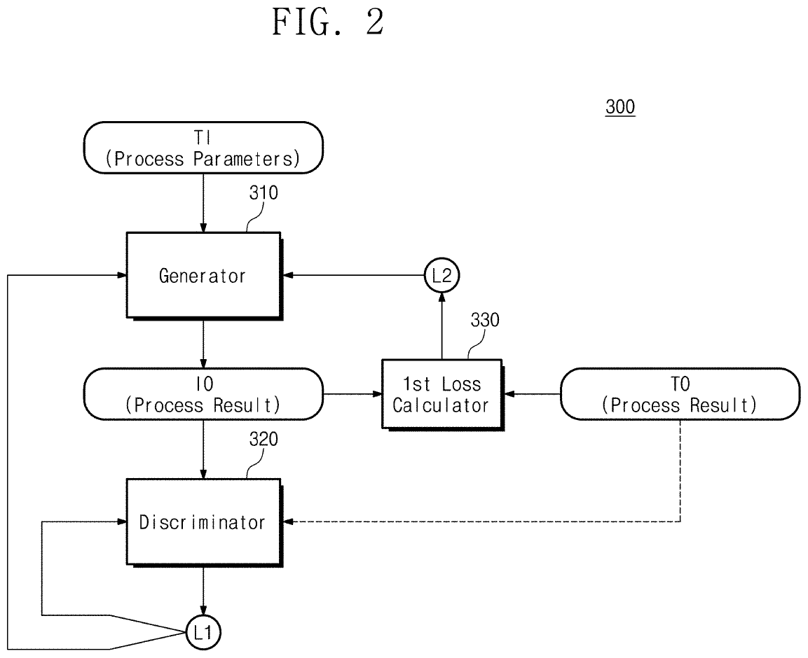

FIG. 1 is a block diagram illustrating a computing device 100 according to at least one embodiment of the inventive concepts. Referring to FIG. 1, the computing device 100 includes processors 110, a random access memory 120, a device driver 130, a storage device 140, a modem 150, and user interfaces 160. According to at least some example embodiments, the computing device 100 may implement one or more semiconductor process machine learning modules, examples of which will be discussed in greater detail below with reference to FIGS. 2-12 (e.g., modules 200, 300, 400, 500, 600, 700 and/or 800), and may cause the machine learning modules to learn, for example, by training the machine learning modules and/or elements of the machine learning modules (e.g., by using training information including training data sets such as training input data and corresponding training output data).

According to at least some example embodiments of the inventive concepts, the computing device 100 may include processing circuitry. The processing circuitry may include one or more circuits or circuitry (e.g., hardware) specifically structured to carry out and/or control some or all of the operations described in the present disclosure as being performed by a computing device (e.g., computing device 100), a semiconductor process machine learning module (e.g., modules 200, 300, 400, 500, 600, 700 and/or 800), or an element of a computing device or semiconductor process machine learning module. According to at least one example embodiment of the inventive concepts, the processing circuitry may include memory and one or more processors (e.g., processors 110) executing computer-readable code (e.g., software and/or firmware) that is stored in the memory and includes instructions for causing the one or more processors to carry out and/or control some or all of the operations described in the present disclosure as being performed by a computing device and/or a semiconductor process machine learning module (or an element thereof). According to at least one example embodiment of the inventive concepts, the processing circuitry may include, for example, a combination of the above-referenced hardware and one or more processors executing computer-readable code.

In at least some example embodiments of the inventive concepts, a semiconductor process machine learning module (e.g., modules 200, 300, 400, 500, 600, 700 and/or 800) or an element thereof (e.g., a generator, discriminator, encoder, combination module, etc.) may utilize one or more of a variety of artificial neural network organizational and processing models, such as convolutional neural networks (CNN), deconvolutional neural networks, recurrent neural networks (RNN) optionally including long short-term memory (LSTM) units and/or gated recurrent units (GRU), stacked neural networks (SNN), state-space dynamic neural networks (SSDNN), deep belief networks (DBN), generative adversarial networks (GANs), and/or restricted Boltzmann machines (RBM).

Alternatively or additionally, such machine learning modules may include other forms of machine learning models, such as, for example, linear and/or logistic regression, statistical clustering, Bayesian classification, decision trees, dimensionality reduction such as principal component analysis, and expert systems; and/or combinations thereof, including ensembles such as random forests.

At least one of the processors 110 may execute a semiconductor process machine learning module 200. The semiconductor process machine learning module 200 may be configured to infer and learn semiconductor process result information from semiconductor process parameters indicating settings of devices and resources that are used in a semiconductor process.

For example, the semiconductor process machine learning module 200 may be implemented in the form of instructions (or codes) that are executed by at least one of the processors 110. In this case, the at least one processor may load the instructions (or codes) of the semiconductor process machine learning module 200 to the random access memory 120.

For another example, the at least one processor may be manufactured to implement the semiconductor process machine learning module 200. For another example, the at least one processor may be manufactured to implement various machine learning modules. The at least one processor may implement the semiconductor process machine learning module 200 by receiving information corresponding to the semiconductor process machine learning module 200.

The processors 110 may include, for example, at least one general-purpose processor such as a central processing unit (CPU) 111 or an application processor (AP) 112. Also, the processors 110 may further include at least one special-purpose processor such as a neural processing unit (MPU) 113, a neuromorphic processor 114, or a graphics processing unit (GPU) 115. The processors 110 may include two or more homogeneous processors.

The random access memory 120 may be used as a working memory of the processors 110 and may be used as a main memory or a system memory of the computing device 100. The random access memory 120 may include a volatile memory such as a dynamic random access memory or a static random access memory or a volatile memory such as a phase-change random access memory, a ferroelectric random access memory, a magnetic random access memory, or a resistive random access memory.

The device driver 130 may control the following peripheral devices depending on a request of the processors 110: the storage device 140, the modem 150, and the user interfaces 160. The storage device 140 may include a stationary storage device such as a hard disk drive or a solid state drive, or a removable storage device such as an external hard disk drive, an external solid state drive, or a removable memory card.

The modem 150 may provide remote communicate with an external device. The modem 150 may perform wired or wireless communication with the external device.

The user interfaces 160 may include user interface circuitry configured to receive information from a user and may provide information to the user. For example, the user interface circuitry may be configured to output information to the user. For example, the user interfaces 160 may include at least one user output interface such as a display or a speaker, and at least one user input interface such as mice, a keyboard, or a touch input device.

The computing device 100 according to at least one embodiment of the inventive concepts may perform the learning of the semiconductor process machine learning module 200, for example, by training the semiconductor process machine learning module 200 using training information including training data sets (e.g., training input and corresponding training output). In particular, the computing device 100 may further improve the reliability of the semiconductor process machine learning module 200 by performing the learning of the semiconductor process machine learning module 200 based on two or more machine learning systems.

FIG. 2 illustrates an example of a semiconductor process machine learning module 300 according to at least a first example embodiment of the inventive concepts. According to at least one example embodiment of the inventive concepts, the semiconductor process machine learning module 300 of a learning mode is illustrated in FIG. 2. Referring to FIGS. 1 and 2, the semiconductor process machine learning module 300 may include a generator 310 and a discriminator 320.

The generator 310 may receive a true input TI. For example, the true input TI may be transferred from the random access memory 120, the storage device 140, the modem 150, or the user interfaces 160 to the semiconductor process machine learning module 300 implemented by at least one of the processors 110.

The true input TI may include semiconductor process parameters including settings of devices and resources that are used in a semiconductor process. For example, the semiconductor process parameters may include parameters that are used in an actual semiconductor process or parameters that are used as an input of a computer simulation.

The generator 310 may generate an inferred output IO, based on the learned algorithm. The inferred output IO may include semiconductor process result information that is inferred as being obtained when a semiconductor process progresses by using the process parameters of the true input TI.

The discriminator 320 may receive the inferred output IO. The discriminator 320 may determine whether the inferred output IO is true or fake. For example, when it is determined that the inferred output IO is a result of inference, the discriminator 320 may discriminate the inferred output IO as fake. For example, when it is determined that the inferred output IO is a result of an actual process, the discriminator 320 may discriminate the inferred output IO as true.

According to at least one example embodiment of the inventive concepts, the discriminator 320 may further receive a true output TO. The true output TO may include semiconductor process result information that is obtained when a semiconductor process progresses by using the true input TI. According to at least some example embodiments, the semiconductor process result information included in the true output TO may also be referred to in the present disclosure as reference semiconductor process result information. The true output TO may include result information of an actual process or result information of a process that is obtained through a computer simulation.

For example, the true output TO may be transferred from the random access memory 120, the storage device 140, the modem 150, or the user interfaces 160 to the semiconductor process machine learning module 300 implemented by at least one of the processors 110.

The discriminator 320 may discriminate which of the inferred output JO and the true output TO is true and which of the inferred output JO and the true output TO is fake. For example, the discriminator 320 may discriminate fake probabilities or true probabilities of each of the inferred output JO and the true output TO.

A discrimination result of the discriminator 320 may be a first loss L1. An algorithm of the generator 310 and an algorithm of the discriminator 320 may be updated based on the first loss L1. According to at least one example embodiment of the inventive concepts, an algorithm may be an object that performs a series of organized functions generating an output from an input.

For example, the generator 310 and the discriminator 320 may be neural networks. Based on the first loss L1, weight values (or synapse values) of at least one or all of the generator 310 and the discriminator 320 may be updated. According to at least one example embodiment of the inventive concepts, the generator 310 and the discriminator 320 may implement a generative adversarial network (GAN) and may be learned (e.g., via training) based on a system of the generative adversarial network.

The semiconductor process machine learning module 300 may further include a first loss calculator 330. The first loss calculator 330 may calculate a second loss L2 indicating a difference between the inferred output IO and the true output TO. The generator 310 may update an algorithm based on the second loss L2.

As described above, the semiconductor process machine learning module 300 may be learned (or, for example, trained) based on the first loss L1 based on a generative adversarial network system and the second loss L2 based on a supervised learning system. Because the semiconductor process machine learning module 300 is learned by two or more machine learning systems, the reliability of the semiconductor process machine learning module 300 may be further improved.

According to at least one example embodiment of the inventive concepts, the generator 310 and the discriminator 320 may be implemented by the same processor or different processors.

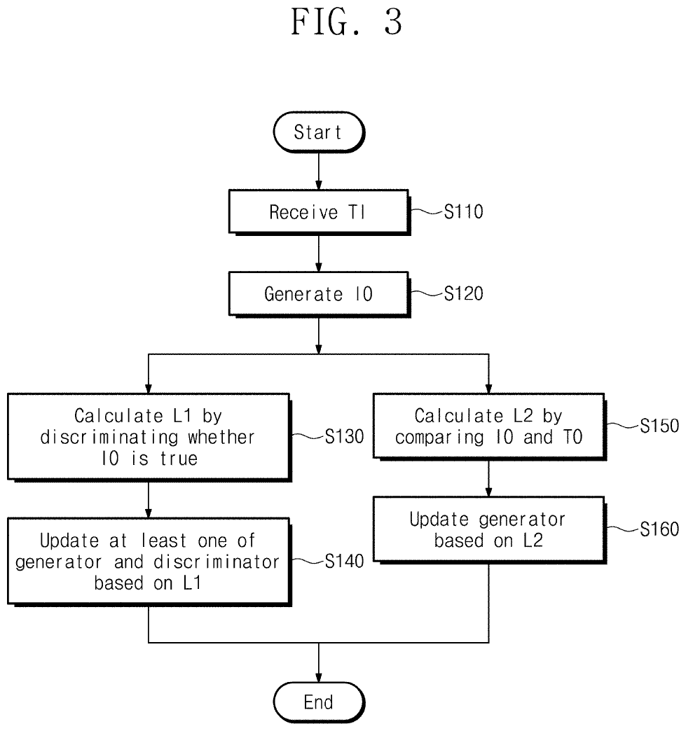

FIG. 3 is a flowchart illustrating an operating method of the semiconductor process machine learning module 300 of FIG. 2. Referring to FIGS. 2 and 3, in operation S110, the generator 310 may receive the true input TI. In operation S120, the generator 310 may generate the inferred output 10.

In operation S130, the discriminator 320 may calculate the first loss L1 by discriminating whether the inferred output IO is true. In operation S140, the semiconductor process machine learning module 300 may update at least one of the algorithm of the generator 310 and the algorithm of the discriminator 320, based on the first loss L1.

In operation S150, the first loss calculator 330 may calculate the second loss L2 by comparing the inferred output IO and the true output TO. In operation S160, the semiconductor process machine learning module 300 may update the algorithm of the generator 310 based on the second loss L2.

According to at least one example embodiment of the inventive concepts, the learning in operation S130 and operation S140 and the learning in operation S150 and operation S160 may be performed in parallel. In another embodiment, the learning in operation S130 and operation S140 and the learning in operation S150 and operation S160 may be selectively performed. The semiconductor process machine learning module 300 may be configured to perform one of the learning in operation S130 and operation S140 and the learning in operation S150 and operation S160.

In another embodiment, the semiconductor process machine learning module 300 may be configured to alternately perform the learning in operation S130 and operation S140 and the learning in operation S150 and operation S160. The semiconductor process machine learning module 300 may be configured to mainly perform one of the learning in operation S130 and operation S140 and the learning in operation S150 and operation S160 and to periodically perform the other learning.

In another embodiment, the semiconductor process machine learning module 300 may be configured to perform one of the learning in operation S130 and operation S140 and the learning in operation S150 and operation S160 and to iterate the selected learning. When a loss of the selected learning is smaller than a threshold, the semiconductor process machine learning module 300 may select the other learning and may iterate the selected learning.

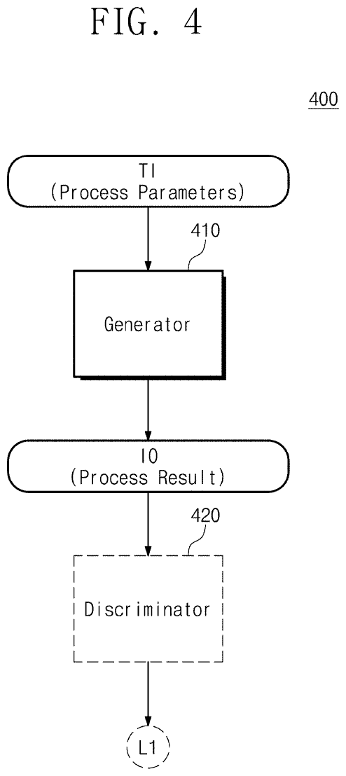

FIG. 4 illustrates an example of a semiconductor process machine learning module 400 according to at least a second example embodiment of the inventive concepts. According to at least one example embodiment of the inventive concepts, the semiconductor process machine learning module 400 of an inference mode is illustrated in FIG. 4. Referring to FIGS. 1 and 4, the semiconductor process machine learning module 400 may include a generator 410.

As described with reference to FIGS. 2 and 3, the generator 410 may be in a state where the learning is completed based on the generative adversarial network system and the supervised learning system. The generator 410 may receive the true input TI and may generate the inferred output IO from the true input TI.

For example, the true input TI may be transferred from the random access memory 120, the storage device 140, the modem 150, or the user interfaces 160 to the semiconductor process machine learning module 400 implemented by at least one of the processors 110. The semiconductor process machine learning module 400 may provide the user with the inferred output IO through at least one of the user interfaces 160.

Optionally, the semiconductor process machine learning module 400 may further include a discriminator 420. As described with reference to FIGS. 2 and 3, the discriminator 420 may be in a state where the learning is completed based on the generative adversarial network system. The discriminator 420 may generate the first loss L1 indicating whether the inferred output IO is true or fake.

For example, the discriminator 420 may generate a score indicating the probability that the inferred output IO is true or the probability that the inferred output IO is fake, as the first loss L1. The semiconductor process machine learning module 400 may provide the user with the first loss L1 through at least one of the user interfaces 160.

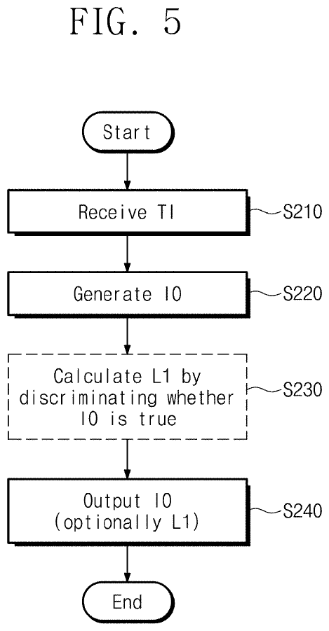

FIG. 5 is a flowchart illustrating an operating method of the semiconductor process machine learning module 400 of FIG. 4. Referring to FIGS. 4 and 5, in operation S210, the generator 410 may receive the true input TI. In operation S220, the generator 410 may generate the inferred output IO from the true input TI based on the machine learning.

Optionally, in operation S230, the discriminator 420 may calculate the first loss L1 by discriminating whether the inferred output IO is true. In operation S240, the semiconductor process machine learning module 400 may output the inferred output IO to the user. Optionally, the semiconductor process machine learning module 400 may further output the first loss L1 to the user.

According to at least one example embodiment of the inventive concepts, the semiconductor process machine learning module 400 may generate the inferred output IO from the true input TI based on the machine learning without complicated calculations. Accordingly, a time and a resource for obtaining a result of a semiconductor process are reduced.

Also, the semiconductor process machine learning module 400 may further provide the user with the first loss L1 indicating that the inferred output IO is true. The first loss L1 may be used as an index indicating the reliability of the inferred output 10.

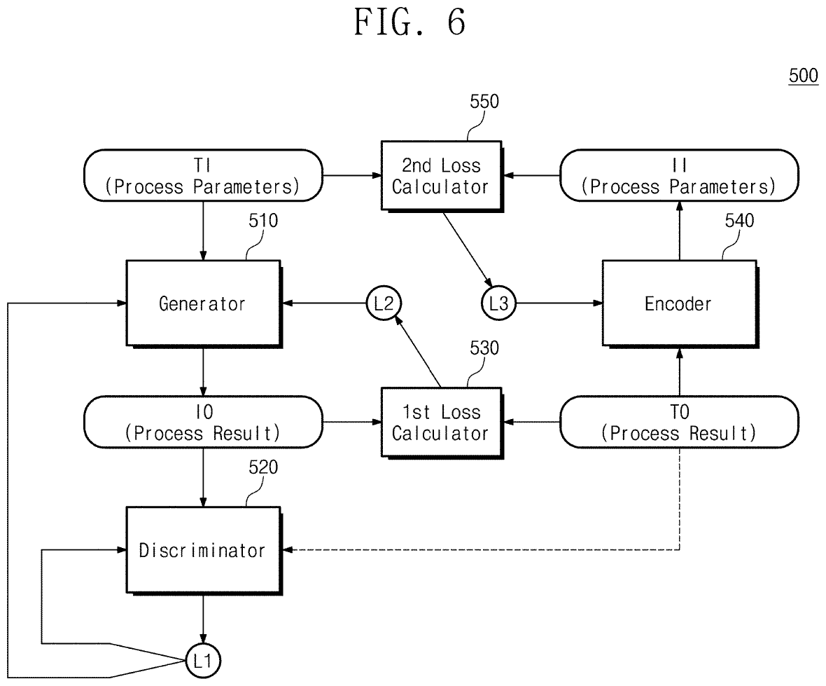

FIG. 6 illustrates an example of a semiconductor process machine learning module 500 according to at least a third example embodiment of the inventive concepts. According to at least one example embodiment of the inventive concepts, the semiconductor process machine learning module 500 of a learning mode is illustrated in FIG. 6. Referring to FIGS. 1 and 6, the semiconductor process machine learning module 500 may include a generator 510, a discriminator 520, a first loss calculator 530, an encoder 540, and a second loss calculator 550.

Like the generator 310 described with reference to FIG. 2, the generator 510 may generate the inferred output IO from the true input TI. The generator 510 may be learned (or, for example, trained) based on the generative adversarial network system generating the first loss L1; the generator 510 may be learned (or, for example, trained) based on the supervised learning system generating the second loss L2.

Like the discriminator 320 described with reference to FIG. 2, the discriminator 520 may generate the first loss L1 from the inferred output IO and the true output TO. The discriminator 520 may be learned (or, for example, trained) based on the generative adversarial network system generating the first loss L1.

Compared with the semiconductor process machine learning module 300 of FIG. 2, the semiconductor process machine learning module 500 may further include the encoder 540 and the second loss calculator 550. The encoder 540 may be learned (or, for example, trained) to generate an inferred input II from the true output TO.

The second loss calculator 550 may calculate a third loss L3 indicating a difference between the true input TI and the inferred input II. The encoder 540 may be learned (or, for example, trained) based on the supervised learning system generating the third loss L3.

According to at least one example embodiment of the inventive concepts, the inferred output IO or the true output TO may include hundreds to thousands of kinds (or dimensions) of information. The inferred input II or the true input TI may include dozens (e.g., 14) of kinds (or dimensions) of information. The encoder 540 is named in terms of a decrease in the number of information, but a function of the encoder 540 is not limited by the name of the encoder 540.

According to at least one example embodiment of the inventive concepts, the encoder 540 may be identical to the generator 510 (or may be learned/trained like generator 510) and may include an algorithm in which an input and an output are exchanged. That is, when the algorithm of the encoder 540 is learned (e.g., updated) by the third loss L3, the algorithm of the generator 510 may also be learned (or updated), for example, through training. In contrast, when the algorithm of the generator 510 is learned by the first loss L1 or the second loss L2, the algorithm of the encoder 540 may also be learned (or, for example, trained).

An example is illustrated in FIG. 6 as the encoder 540 generates the inferred input II from the true output TO, but the encoder 540 may be configured to generate the inferred input II from the inferred output IO. The encoder 540 may be configured to select the true output TO and the inferred input II as an input in turn, at a given ratio, or at a given period.

According to at least one example embodiment of the inventive concepts, the generator 510 and the encoder 540 may constitute an auto encoder system. The generator 510 may receive more dimensions (or kinds) of the inferred output IO from less dimensions (or kinds) of the inferred output IO. The encoder 540 may generate the inferred input II from the true output TO of a higher dimension.

The algorithm of the generator 510 and the algorithm of the encoder 540 may be learned (or updated), for example, through training, based on the auto encoder system including the third loss L3 indicating a difference between the true input TI and the inferred input II.

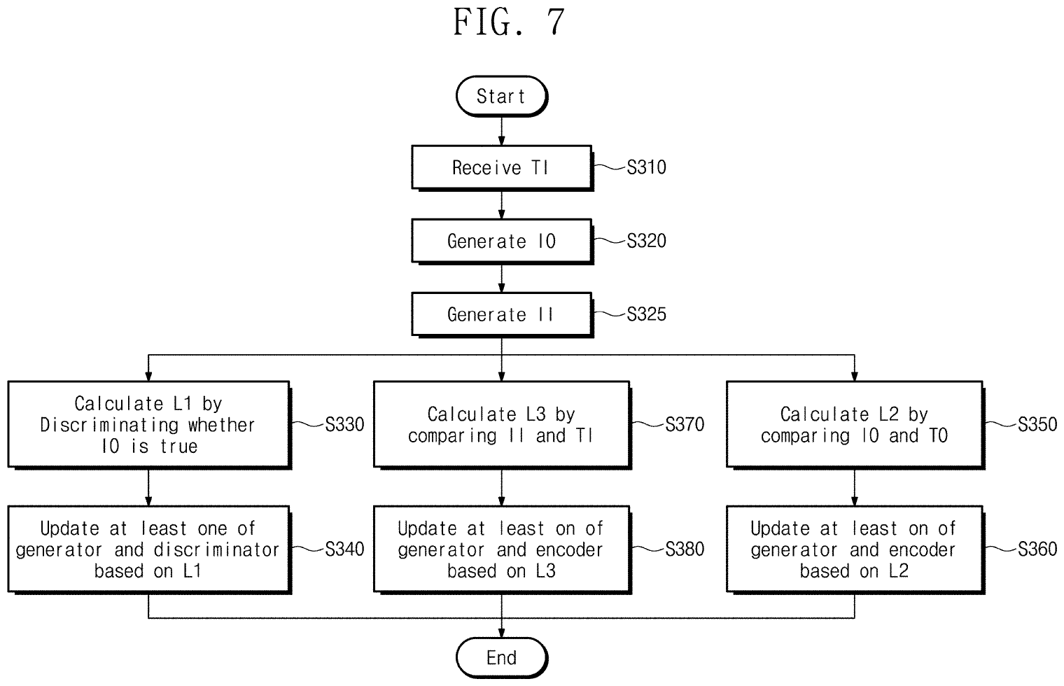

FIG. 7 is a flowchart illustrating an operating method of the semiconductor process machine learning module 500 of FIG. 6. Referring to FIGS. 6 and 7, in operation S310, the generator 510 may receive the true input TI. In operation S320, the generator 510 may generate the inferred output IO from the true input TI. In operation S325, the encoder 340 may generate the inferred input II from the true output TO or the inferred output IO.

In operation S330, the discriminator 320 may calculate the first loss L1 by discriminating whether the inferred output IO is true. In operation S340, an algorithm of at least one of the generator 510 and the discriminator 520 may be updated based on the first loss L1.

In operation S350, the second loss L2 may be calculated by comparing the inferred output IO and the true output TO. In operation S360, an algorithm of at least one of the generator 510 and the encoder 540 may be updated based on the second loss L2.

In operation S360, the third loss L3 may be calculated by comparing the inferred input II and the true input TI. In operation S380, an algorithm of at least one of the generator 510 and the encoder 540 may be updated based on the third loss L3.

According to at least one example embodiment of the inventive concepts, the learning (e.g., a first learning) in operation S330 and operation S340, the learning (e.g., a second learning) in operation S350 and operation S360, and the learning (e.g., a third learning) in operation S370 and operation S380 may be performed in parallel. In another embodiment, the first learning, the second learning, and the third learning may be selectively performed. The semiconductor process machine learning module 500 may be configured to select and perform one of the first learning, the second learning, and the third learning.

In another embodiment, the semiconductor process machine learning module 500 may be configured to perform the first learning, the second learning, and the third learning in turn. The semiconductor process machine learning module 500 may be configured to mainly perform one of the first learning, the second learning, and the third learning and to periodically perform the remaining learnings.

In another embodiment, the semiconductor process machine learning module 500 may be configured to select one of the first learning, the second learning, and the third learning and to iterate the selected learning. When a loss of the selected learning is smaller than a threshold, the semiconductor process machine learning module 500 may select another learning and may iterate the selected learning.

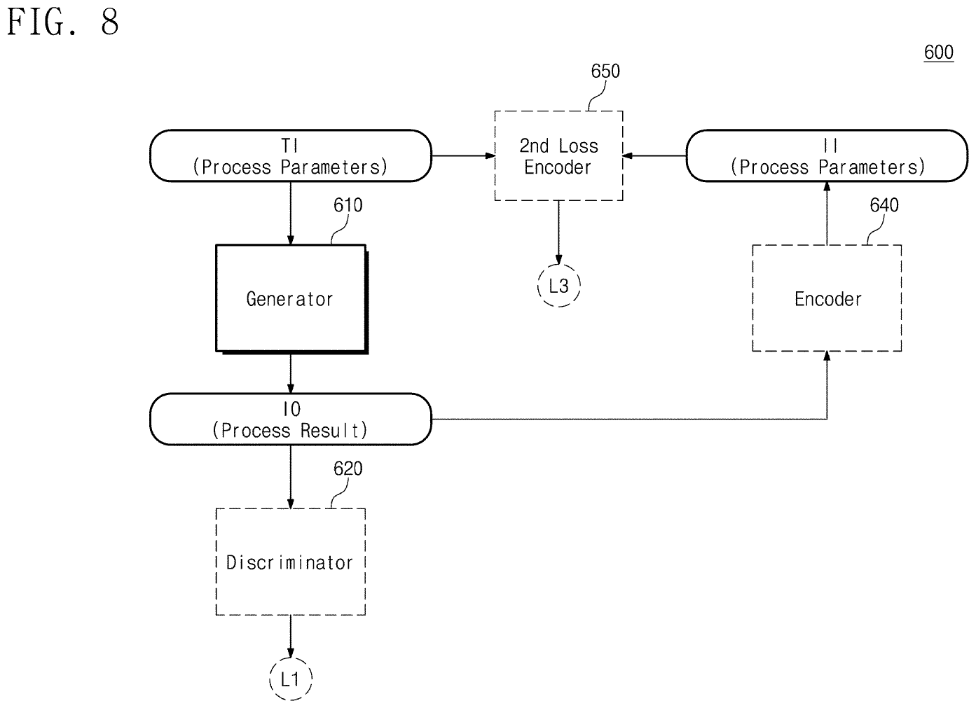

FIG. 8 illustrates an example of a semiconductor process machine learning module 600 according to at least a fourth example embodiment of the inventive concepts. According to at least one example embodiment of the inventive concepts, the semiconductor process machine learning module 600 of an inference mode is illustrated in FIG. 8. Referring to FIGS. 1 and 8, the semiconductor process machine learning module 600 may include a generator 610.

As described with reference to FIGS. 6 and 7, the generator 610 may be in a state where the learning is completed based on at least one of the generative adversarial network system, the supervised learning system, and the auto encoder system. The generator 610 may receive the true input TI and may generate the inferred output IO from the true input TI.

For example, the true input TI may be transferred from the random access memory 120, the storage device 140, the modem 150, or the user interfaces 160 to the semiconductor process machine learning module 600 implemented by at least one of the processors 110. The semiconductor process machine learning module 600 may provide the user with the inferred output IO through at least one of the user interfaces 160.

Optionally, the semiconductor process machine learning module 600 may further include a discriminator 620. As described with reference to FIGS. 6 and 7, the discriminator 620 may be in a state where the learning is completed based on the generative adversarial network system. The discriminator 620 may generate the first loss L1 indicating whether the inferred output IO is true or fake.

For example, the discriminator 620 may generate a score indicating the probability that the inferred output IO is true or the probability that the inferred output IO is fake, as the first loss L1. The semiconductor process machine learning module 600 may provide the user with the first loss L1 through at least one of the user interfaces 160.

Optionally, the semiconductor process machine learning module 600 may further include an encoder 640. As described with reference to FIGS. 6 and 7, the encoder 640 may be in a state where the learning is completed based on at least one of the supervised learning system and the auto encoder system.

The encoder 640 may generate the inferred input II from the inferred output 10. A second loss calculator 650 may calculate the third loss L3 indicating a difference between the true input TI and the inferred input II. The semiconductor process machine learning module 600 may provide the user with the third loss L3 through at least one of the user interfaces 160.

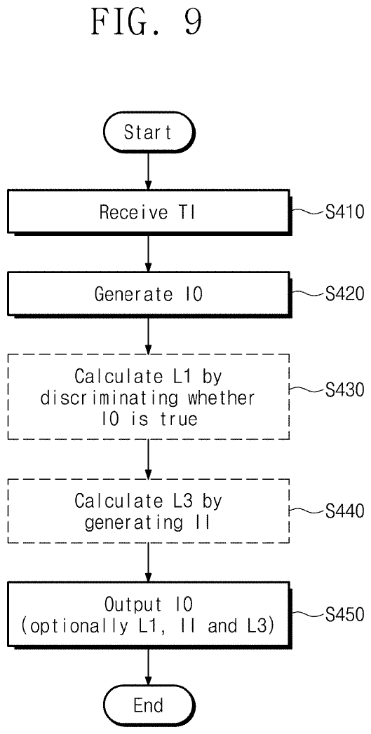

FIG. 9 is a flowchart illustrating an operating method of the semiconductor process machine learning module 600 of FIG. 8. Referring to FIGS. 8 and 9, in operation S410, the generator 610 may receive the true input TI. In operation S420, the generator 610 may generate the inferred output IO from the true input TI.

Optionally, in operation S430, the discriminator 620 may calculate the first loss L1 by discriminating whether the inferred output IO is true. Optionally, in operation S440, the encoder 640 may generate the inferred input II from the inferred output 10, and the second loss calculator 650 may calculate the third loss L3.

In operation S450, the semiconductor process machine learning module 600 may output the inferred output IO to the user. Optionally, the semiconductor process machine learning module 600 may further provide the user with at least one of the first loss L1, the inferred input II, and the third loss L3.

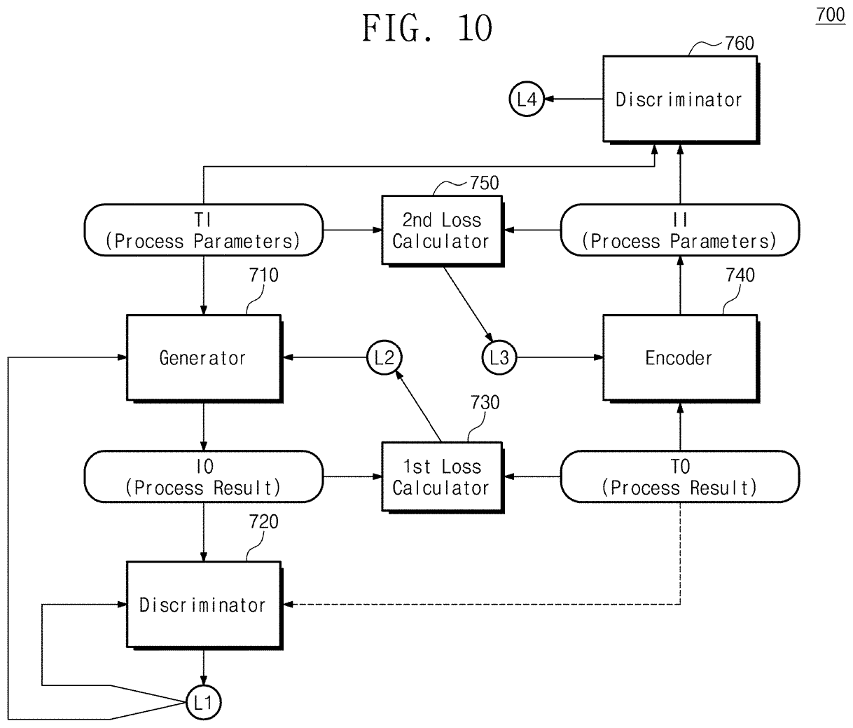

FIG. 10 illustrates an example of a semiconductor process machine learning module 700 according to at least a fifth example embodiment of the inventive concepts. According to at least one example embodiment of the inventive concepts, the semiconductor process machine learning module 700 of a learning mode is illustrated in FIG. 10. Referring to FIGS. 1 and 10, the semiconductor process machine learning module 700 may include a generator 710, a discriminator 720, a first loss calculator 730, an encoder 740, a second loss calculator 750, and an additional discriminator 760.

Like the generator 310 described with reference to FIG. 2, the generator 710 may generate the inferred output IO from the true input TI. The generator 710 may be learned (or, for example, trained) based on at least one of the first loss L1 and the second loss L2.

Like the discriminator 320 described with reference to FIG. 2, the discriminator 720 may generate the first loss L1 from the inferred output IO and the true output TO. The discriminator 720 may be learned (or, for example, trained) based on the first loss L1.

The encoder 740 may generate the inferred input II from the true output TO or the inferred output 10. The second loss calculator 550 may calculate the third loss L3 indicating a difference between the true input TI and the inferred input II.

Compared with the semiconductor process machine learning module 500 of FIG. 6, the semiconductor process machine learning module 700 may further include the additional discriminator 760. The additional discriminator 760 may receive the true input TI and the inferred input II and may generate a fourth loss L4 indicating whether the true input TI and the inferred input II are true or fake.

According to at least one example embodiment of the inventive concepts, the additional discriminator 760 may implement an additional generative adversarial network system together with the encoder 740. The encoder 740 may implement the generation of the generative adversarial network system, and the additional discriminator 760 may implement the discrimination of the generative adversarial network system. That is, an algorithm of the encoder 740 and an algorithm of the additional discriminator 760 may be learned (or, for example, trained) based on the fourth loss L4.

In another embodiment, the additional discriminator 760 may implement the generative adversarial network system together with the auto encoder system of the generator 710 and the encoder 740. The auto encoder system of the generator 710 and the encoder 740, which generates the inferred output IO from the true input TI and generates the inferred input II from the inferred output IO may implement the generation of the generative adversarial network system.

The additional discriminator 760 may implement the discrimination of the generative adversarial network system. That is, an algorithm of the generator 710, an algorithm of the encoder 740, and an algorithm of the additional discriminator 760 may be updated.

In another embodiment, the discriminator 720 may implement the generative adversarial network system together with the generator 710 and the encoder 740. The encoder 740 may generate the inferred input II from the true output TO. The generator 710 may generate the inferred output IO from the inferred input II.

The discriminator 720 may generate the first loss L1 indicating whether the true output TO and the inferred output IO are true or fake. At least one of the algorithm of the generator 710, the algorithm of the encoder 740, and the algorithm of the discriminator 720 may be learned (or, for example, trained) based on the first loss L1.

According to at least one example embodiment of the inventive concepts, the learning based on each of the first to fourth losses L1 to L4, or the learning of each of the generator 710, the discriminator 720, the encoder 740, and the additional discriminator 760 may be performed selectively, alternately, or periodically.

After the learning of the semiconductor process machine learning module 700 is completed, the semiconductor process machine learning module 700 may be set to an inference mode. In the inference mode, the first loss calculator 730 may be removed. The discriminator 720, the encoder 740, the second loss calculator 750, and the additional discriminator 760 may be optional.

In the inference mode, the semiconductor process machine learning module 700 may output the inferred output IO to the user. In the inference mode, the semiconductor process machine learning module 700 may optionally provide the user with the first loss L1, the third loss L3, the fourth loss L4, and the inferred input II.

In the above embodiments, process parameters mentioned as inputs such as the true input TI and the inferred input II may include at least one of a target dimension indicating a target shape after manufactured, a material indicating a material to be used, an ion implantation process (IIP) condition indicating conditions of an ion implantation process, an annealing condition indicating a condition of an anneal process, an epi condition indicating a condition of an epitaxial growth process, a cleaning condition indicating a condition of a cleaning process, and a bias indicating levels of voltages to be input to contacts of a device.

In the above embodiments, process results mentioned as outputs such as the true output TO and the inferred output IO may include at least one of a doping profile indicating a profile of a dopant in a device generated due to an ion implantation process, an electric field profile indicating a profile of an electric field in a device generated depending on levels of biased voltages, a mobility profile of mobility of an electron or hole in a device caused depending on levels of biased voltages, a carrier density profile indicating a profile of an electron or hole in a device caused depending on levels of biased voltages, a potential profile indicating a profile of a potential in a device caused depending on levels of biased voltages, an energy band profile indicating a profile of a valence or conduction band in a device caused depending on levels of biased voltages, a current profile indicating a profile of currents in a device caused depending on levels of biased voltages, and others (ET) indicating characteristics extracted by a specified method, such as a threshold voltage and a driving current in a device.

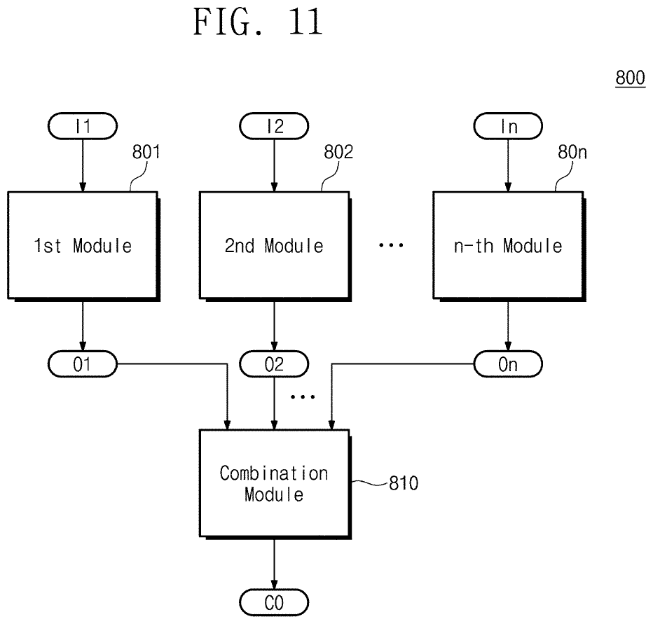

FIG. 11 illustrates an example of a semiconductor process machine learning module 800 according to at least one example embodiment of the inventive concepts. Referring to FIG. 11, the semiconductor process machine learning module 800 may include first to n-th modules 801 to 80n, and a combination module 810. Each of the first to n-th modules 801 to 80n may include one of the semiconductor process machine learning modules 200, 300, 400, 500, 600, and 700 described with reference to FIGS. 1 to 10.

The first to n-th modules 801 to 80n may receive first to n-th inputs I1 to In, respectively. The first to n-th inputs I1 to In may include true inputs or inferred inputs. The first to n-th modules 801 to 80n may generate first to n-th outputs O1 to On from the first to n-th inputs I1 to In, respectively. The first to n-th outputs O1 to On may include inferred outputs.

The first to n-th modules 801 to 80n may receive different inputs or the same inputs. The first to n-th modules 801 to 80n may be semiconductor process machine learning modules learned in the same manner or in different manners.

The combination module 810 may receive the first to n-th outputs O1 to On. The combination module 810 may be a neural network learned to process the first to n-th outputs O1 to On or may be one of the user interfaces 160 providing the user with the first to n-th outputs O1 to On.

In some of physical computer simulations, different outputs may be calculated with respect to the same inputs. The first to n-th modules 801 to 80n may be learned (or, for example, trained) based on cases in which different outputs are calculated with respect to the same inputs. That is, the semiconductor process machine learning module 800 may be implemented to learn and infer a computer simulation in which different outputs are calculated with respect to the same inputs.

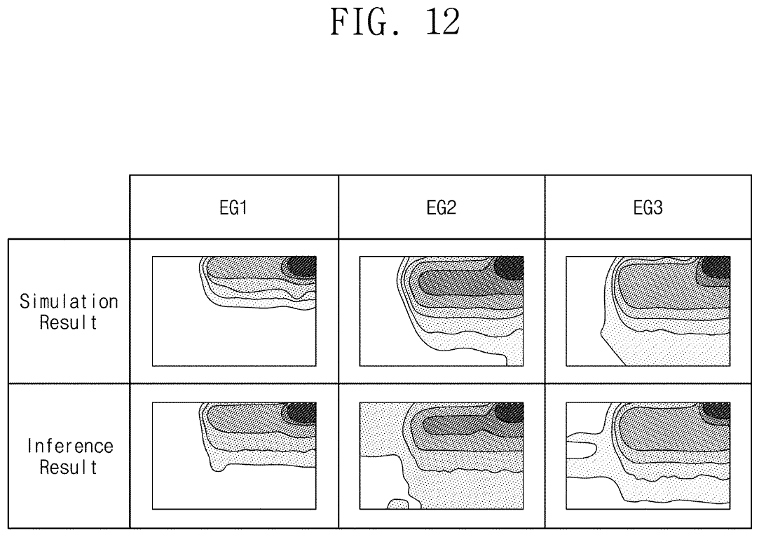

FIG. 12 illustrates a result of a physical computer simulation and an inference result of a semiconductor process machine learning module. Referring to FIG. 12, first to third examples EG1 to EG3 show results of a physical computer simulation and inference results of a semiconductor process machine learning module in the case of implanting a dopant into a semiconductor substrate.

In FIG. 12, as the density of dots increases, the density of dopant may increase. It is understood from FIG. 12 that a computation result of a physical computer simulation and an inference result of a semiconductor process machine learning module are inferred to be similar. As the learning of the semiconductor process machine learning module further progresses, the inference result of the semiconductor process machine learning module may infer the computation result of the physical computer simulation to be more approximate.

In the above embodiments, components according to the inventive concept are described by using the terms “first”, “second”, “third”, and the like. However, the terms “first”, “second”, “third”, and the like may be used to distinguish components from each other and do not limit the inventive concept. For example, the terms “first”, “second”, “third”, and the like do not involve an order or a numerical meaning of any form.

At least some example embodiments of the inventive concepts are described above by using blocks. The blocks may be implemented with various hardware devices, such as an integrated circuit, an application specific IC (ASCI), a field programmable gate array (FPGA), and a complex programmable logic device (CPLD), firmware driven in hardware devices, software such as an application, or a combination of a hardware device and software. Also, the blocks may include circuits implemented with semiconductor elements in an integrated circuit or circuits enrolled as intellectual property (IP).

According to at least some example embodiments of inventive concepts, a machine learning module is learned based on a combination of two or more machine learning systems. Accordingly, a computing device including a machine learning module to infer a result of a semiconductor process from semiconductor process parameters with higher accuracy, an operating method of the computing device, and a storage medium storing instructions of the machine learning module are provided.

Example embodiments of the inventive concepts having thus been described, it will be obvious that the same may be varied in many ways. Such variations are not to be regarded as a departure from the intended spirit and scope of example embodiments of the inventive concepts, and all such modifications as would be obvious to one skilled in the art are intended to be included within the scope of the following claims.

What is claimed is:

1. A computing device comprising:
memory storing computer-executable instructions; and
processing circuitry configured to execute the computer-executable instructions such that the processing circuitry is configured to
operate as a machine learning generator configured to receive semiconductor process parameters, to generate semiconductor process result information from the semiconductor process parameters, and to output the generated semiconductor process result information; and
operate as a machine learning discriminator configured to receive the generated semiconductor process result information from the machine learning generator and to generate a discrimination result by discriminating whether the generated semiconductor process result information is true.

2. The computing device of claim 1, wherein the processing circuitry is further configured to execute the computer-executable instructions such that at least one of the machine learning generator and the machine learning discriminator is further configured to perform learning to update an algorithm based on the discrimination result.

3. The computing device of claim 1, wherein the processing circuitry is further configured to execute the computer-executable instructions such that the processing circuitry is further configured to
compare the generated semiconductor process result information and reference semiconductor process result information,
calculate a loss indicating a difference between the generated semiconductor process result information and the reference semiconductor process result information, and
update an algorithm based on the loss by training the machine learning generator.

4. The computing device of claim 1, wherein the processing circuitry is further configured to execute the computer-executable instructions such that the machine learning discriminator further receives reference semiconductor process result information, and the machine learning discriminator is further configured to discriminate one of the generated semiconductor process result information and the reference semiconductor process result information as true and the other as fake.

5. The computing device of claim 1, further comprising:
a user interface circuitry configured to output at least one of the generated semiconductor process result information and the discrimination result to a user.

6. The computing device of claim 1, wherein the processing circuitry is configured to execute the computer-executable instructions such that the processing circuitry is further configured to operate as a machine learning encoder configured to receive a reference semiconductor process result and to generate semiconductor process parameters inferred from the reference semiconductor process result.

7. The computing device of claim 6, wherein the processing circuitry is configured to execute the computer-executable instructions such that the processing circuitry is further configured to
compare the semiconductor process parameters and the inferred semiconductor process parameters,
calculate a loss indicating a difference between the semiconductor process parameters and the inferred semiconductor process parameters, and
to update an algorithm based on the loss by training the machine learning encoder.

8. The computing device of claim 7, further comprising:
a user interface circuitry configured to output at least one of the generated semiconductor process result information, the discrimination result, the inferred semiconductor process parameters, and the loss to a user.

9. The computing device of claim 1, wherein the processing circuitry is configured to execute the computer-executable instructions such that the processing circuitry is further configured to operate as a machine learning encoder configured to receive a reference semiconductor process result information and to generate semiconductor process parameters inferred from the semiconductor process result information.

10. The computing device of claim 9, further comprising:
user interface circuitry configured to output at least one of the semiconductor process result information, the discrimination result, and the inferred semiconductor process parameters to a user.

11. The computing device of claim 9, wherein the processing circuitry is configured to execute the computer-executable instructions such that an algorithm of the machine learning encoder is identical to an algorithm of the machine learning generator and the algorithm of the machine learning encoder is an algorithm in which an input and an output are exchanged.

12. The computing device of claim 1, wherein the machine learning generator and the machine learning discriminator are based on a neural network.

13. An operating method of a computing device which includes one or more processors, the method comprising:
performing supervised learning of a machine learning generator generating semiconductor process result information from semiconductor process parameters, by using at least one processor of the one or more processors; and
performing learning of a generative adversarial network implemented with the machine learning generator and a machine learning discriminator, which discriminates whether the generated semiconductor process result information is true, by using the at least one processor.

14. The method of claim 13, wherein the performing of the learning of the generative adversarial network includes performing supervised learning by using the generated semiconductor process result information and a reference semiconductor process result information.

15. The method of claim 13, further comprising:
performing supervised learning of a first encoder generating semiconductor process parameters inferred from reference semiconductor process result information, by using the at least one processor.

16. The method of claim 15, further comprising:
transferring the inferred semiconductor process parameters to the machine learning generator, by using the at least one processor.

17. The method of claim 16, further comprising:
performing learning of an auto encoder implemented with the machine learning generator and the first encoder, based on inferred semiconductor process result information generated from the inferred semiconductor process parameters by the machine learning generator.

18. A non-transitory computer-readable storage medium storing instructions of a semiconductor process machine learning module, wherein the instructions, when executed by one or more processors, cause the one or more processors to perform operations, wherein the operations include:
receiving semiconductor process parameters; and
generating semiconductor process result information from the semiconductor process parameters, and
wherein the semiconductor process machine learning module is a trained module that has been trained based on,
a machine learning generator configured to generate the generated semiconductor process result information from the semiconductor process parameters and trained based on supervised learning, and
a machine learning discriminator configured to discriminate whether the generated semiconductor process result information is true and to implement a generative adversarial network together with the machine learning generator.

19. The non-transitory computer-readable storage medium of claim 18, wherein the operations further includes:
receiving reference semiconductor process result information; and
generating semiconductor process parameters inferred from the reference semiconductor process result information.

20. The non-transitory computer-readable storage medium of claim 19, wherein the semiconductor process machine learning module is trained based on a first encoder configured to generate the inferred semiconductor process parameters from the reference semiconductor process result information and to implement an auto encoder together with the machine learning generator.
